(19) United States
(12) Patent Application Publication
(10) Pub. No.: US 2008/0291378 A1
(43) Pub. Date: Nov. 27, 2008

(54) Transmittance control device and an image display apparatus

(75) Inventor: Takeshi Sasaki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kawasaki (JP)

(21) Appl. No.: 12/153,590

(22) Filed: May 21, 2008

(30) Foreign Application Priority Data
May 22, 2007 (JP) 134984/2007

(51) Int. Cl. G02F 1/133

(52) U.S. Cl. 349/116

(57) ABSTRACT

A transmittance control device which controls a transmittance factor, include a liquid crystal which is sandwiched with a pixel electrode and a common electrode; a control line which a predetermined control signal inputs; and an optical passive element which controls an electric potential difference on the pixel electrode and the common electrode by connecting with the control line, and the pixel electrode and changing a conduction state of the control line and the pixel electrode according to brightness of an incidence light.

### INCORPORATION BY REFERENCE

This application is based upon and claims the benefit of priority from Japanese patent Apply No 2007-134984, filed on May 22, 2007, the disclosure of which is incorporated herein in its entirety by reference.

### BACKGROUND OF THE INVENTION

1. Technical Field

The present invention relates to a transmittance control device and an image display apparatus using the same.

2. Background Art

As an image display apparatus, a liquid crystal display (LCD) apparatus using an LCD device is well known. The LCD apparatus have an advantage of thin shape, light weight, low power consumption or the like. For this reason, the LCD apparatus have practically applied various fields such as office automation equipment, audio visual equipment and portable terminal equipment.

FIG. 17 indicates a cross section of the LCD apparatus 100, and FIG. 18 indicates a plan view of the LCD device 110. The LCD apparatus 100 includes the LCD device 110 and a backlight device 120.

The LCD device 110 includes a pair of transparent substrates 111 and 112, and a liquid crystal 113 sandwiched between these transparent substrates 111 and 112. The transparent substrate 111 is provided with a driving line 114 and a number of pixel electrodes and the transparent substrate 112 are provided with a common electrode (not shown). The driving line 114 consists of scanning lines and data lines, and partitions a display area into a plurality of display pixels 115.

The Liquid crystal molecules of display pixel 115 rotate according to an electric field generated by applied voltage between the pixel electrode and the common electrode. When a light from the back light device 120 passes the liquid crystal 113, this light receives a deflection according to the rotation state of the liquid crystal molecules.

Because a polarizer (not shown) is provided on the emission light side position of the transparent substrate 112, only the light with the same deflection direction as this polarizer is emitted. Therefore, the light corresponding to the voltage value applied between the pixel electrode and the common electrode is emitted from LCD device 110.

When LCD apparatus 100 displays the image, brightness distribution of the emission light of LCD apparatus 100 is changed by controlling the voltage value applied to display pixel 115 according to the image data.

However, it is pointed out that a contrast ratio of the LCD apparatus 100 is low contrast ratio compared with an image display apparatus such as a cathode ray tube (CRT) display which performs self emission of light.

The Japanese Patent Application Laid-Open No. 2007-33813 proposes an LCD apparatus 100A or 100B which improves the contrast ratio by installing a transmittance control (TMC) device 130 as shown in FIG. 19 and FIG. 20.

The LCD apparatus 100A shown in FIG. 19 has a composition which piles up a backlight device 120, an LCD device 110 and a TMC device 130 in this order. The LCD apparatus 100B shown in FIG. 20 has a composition which piles up a backlight device 120, a TMC device 130 and an LCD device 110 in this order.

The TMC device 130 includes an incident side transparent substrate 131, an emission side transparent substrate 132 and a liquid crystal 133 sandwiched between the incident side transparent substrate 131 and the emission side transparent substrate 132.

FIG. 21 is an explanation drawing of the LCD device 110 and the TMC device 130. The incident side transparent substrate 131 is provided with a driving line 134 and a number of pixel electrodes (not shown), and the emission side transparent substrate 132 is provided with a common electrode. This driving line 134 consists of scanning lines and data lines, and partitions a display area into a plurality of TMC pixels 135.

The structure (for example, the pixel number, the pixel interval, and the drive frequency etc.) of the TMC device 130 is almost the same structure as the LCD device 110. Thereby, when assembling the TMC device 130 and the LCD device 110, the TMC pixel 135 is completely aligned with the display pixel 115. And the TMC device 130 is driven synchronizing with the LCD device 110, and as a result, the TMC pixel 135 is driven synchronizing with the display pixel 115.

Accordingly, although a strong brightness light from the display pixel 115 passes the TMC pixel 135 without changing the brightness of light, a weak brightness light from the display pixel 115 changes into a light of weaker brightness, while passing through the TMC pixel 135. As a result, the LCD apparatus 100A or 100B comes to have the high contrast ratio by installing the TMC device 130.

### SUMMARY

An exemplary object of the invention is to provide a transmittance control device of the simple structure, low cost and large contrast ratio, and an image display apparatus using this transmittance control device.

A transmittance control device which controls a transmittance factor, include a liquid crystal which is sandwiched with a pixel electrode and a common electrode; a control line which a predetermined control signal inputs; an optical passive element which controls an electric potential difference on the pixel electrode and the common electrode by connecting with the control line and the pixel electrode, and changing a conduction state of the control line and the pixel electrode according to brightness of incidence light.

### BRIEF DESCRIPTION OF THE DRAWINGS

The Exemplary features and advantages of the present invention will become apparent from the following detailed description when taken with the accompanying drawings.

The explanation for those is as follows:

FIG. 1 is a cross section of a transmittance control device in a first exemplary embodiment;

FIG. 2 is a cross section of an image display apparatus in a second exemplary embodiment;

FIG. 3 is a plan view of a liquid crystal display device in the second exemplary embodiment;

FIG. 4 is a plan view of a transmittance control device in the second exemplary embodiment;

FIG. 5 is a detailed plan view of the transmittance control device in the second exemplary embodiment;

FIG. 6 is a cross section of the transmittance control device along a X-X′ line of FIG. 5 in the second exemplary embodiment;

FIG. 7 is an explanation drawing showing an electric current which flows in an optical passive element in the second exemplary embodiment;

FIG. 8 is a cross section of the transmittance control device with the optical passive element of the different structure in the second exemplary embodiment;

FIG. 9 is a plan view of the transmittance control device provided with a control line which used a translucency material in the second exemplary embodiment;

FIG. 10 is a cross section of the transmittance control device along a Y-Y′ line of FIG. 9 in the second exemplary embodiment;

FIG. 11A is an explanation drawing of a control signal in the second exemplary embodiment;

FIG. 11B is an explanation drawing of a pixel voltage when a weak brightness light is incident into the transmittance control pixel in the second exemplary embodiment;

FIG. 11C is an explanation drawing of a pixel voltage when medium degree brightness light is incident into the transmittance control pixel in the second exemplary embodiment;

FIG. 11D is an explanation drawing of a pixel voltage when a strong brightness light is incident into the transmittance control pixel in the second exemplary embodiment;

FIG. 12A is a sectional view of the liquid crystal display apparatus whose position of the transmittance control device coincides with the position of the liquid crystal display device in the second exemplary embodiment;

FIG. 12B is a cross section of the liquid crystal display apparatus whose position of the transmittance control device does not coincide with the position of the liquid crystal display device in the second exemplary embodiment;

FIG. 13 is a plan view of the transmittance control device with the transmittance control pixel of a hexagon shape in other exemplary embodiments;

FIG. 14 is a plan view of the transmittance control device with the transmittance control pixel of an irregular shape in other exemplary embodiments;

FIG. 15 is a cross section of the transmittance control device having the optical passive element including a joint part with a high impurity concentration in the other exemplary embodiments;

FIG. 16 is a plan view of the transmittance control device of the transverse electric field system in the other exemplary embodiments;

FIG. 17 is a cross section of a liquid crystal display apparatus in a related art;

FIG. 18 is a plan view of a liquid crystal display device in the related art;

FIG. 19 is a cross section of the liquid crystal display apparatus which piles up a backlight device, a liquid crystal display device and a transmittance control device by this order in the related art;

FIG. 20 is a cross section of the liquid crystal display apparatus which piles up a backlight device, a transmittance control device and a liquid crystal display device by this order in a related art; and

FIG. 21 is an explanation drawing such as a shape of the display pixel and the transmittance control pixel in the related art.

### EXEMPLARY EMBODIMENT

Exemplary embodiments of the present invention will now be described in detail in accordance with the accompanying drawings.

### (I) The Consideration of the Related Art

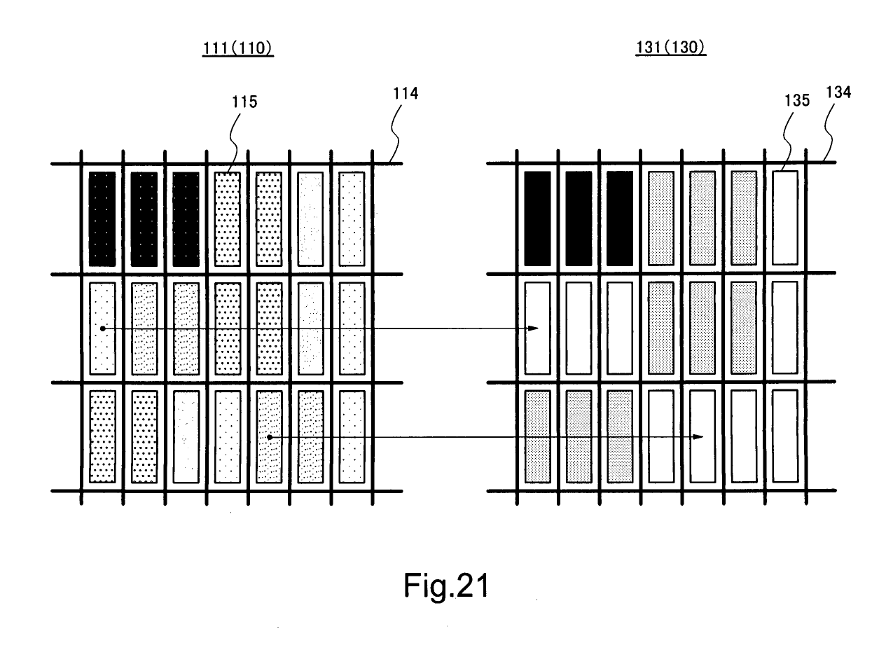

As shown in FIG. 21, the patent document (JP2007-33813) described in the background art discloses the image display apparatus which is assembled from transmittance control (TMC) device 130 and the liquid crystal display (LCD) device 110 while aligning perfectly the positions of TMC pixel 135 and display pixel 115. However, it is very difficult to align those positions perfectly, and therefore a manufacturing cost becomes high.

In order to operate the TMC device 130 synchronizing with the LCD device 110, a synchronizing signal generating circuit and a drive circuit for exclusive use require.

Because a structure of the TMC device 130 is almost the same as the LCD device 110, the structure of the TMC device 130 becomes complicated. Accordingly, the manufacturing cost becomes high according to these factors.

Because the driving line 134 consists of scanning lines and data lines, an occupation area of the driving line 134 becomes large; therefore an opening ratio becomes small.

Based on such consideration, the present invention proposes a TMC device which has features such as the simple structure, the low cost, the large opening ratio and the large contrast ratio, and the image display apparatus which uses this TMC device.

### (II) The First Exemplary Embodiment

The first exemplary embodiment of the present invention will be described the below. The LCD device is used for the image display device in the following explanation. However, a CRT, a PDP (plasma-display panel), and an OLED (organic light emitting diode) may be used. As the LCD device, there are two types of a normally black type and a normally white type. As examples of the normally black type, there is an IPS (In Plane Switching) system, a FFS (Fringe Field Switching) system, and a VA (Vertical Alignment) system.

The following image display apparatus is provided with the LCD device of normally black type which uses TN (Twisted Nematic) liquid crystal.

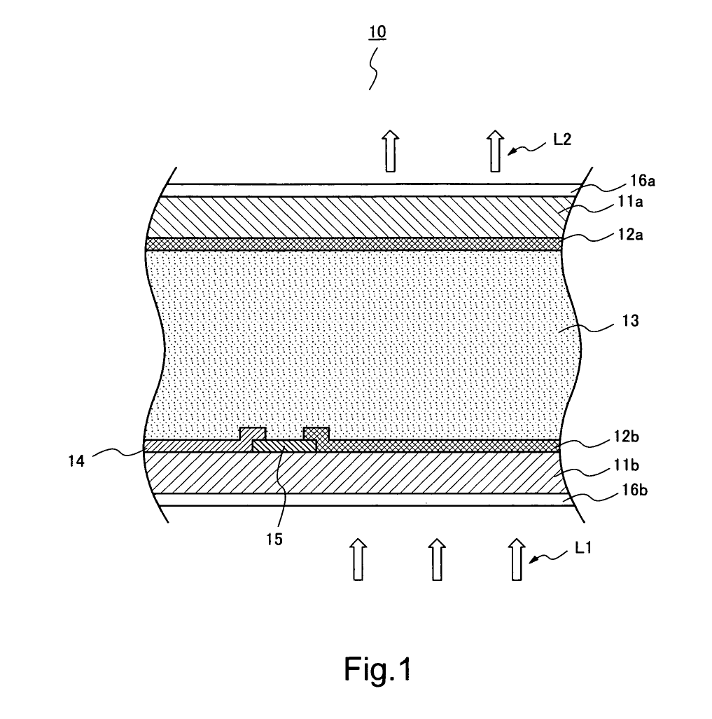

FIG. 1 indicates a cross section of a TMC device. The TMC device 10 includes a liquid crystal 13 sandwiched between a incident side transparent substrate lib and a emission side transparent substrate 11a, an optical passive element 15, a control line 14, a pixel electrode 12b and a common electrode 12a.

Hereinafter “incident side transparent substrate” is described as “INTS”, and “emission side transparent substrate” is described as “EMTS”.

Further, the TMC device 10 is the normally black type that has the smallest of transmittance factor at the smallest pixel voltage value, and indicates the larger amount of transmittance factor according to increase of the pixel voltage value. Here, “pixel voltage value” is an electric potential difference between the pixel electrode 12b and the common electrode 12a. Furthermore, “the smallest pixel voltage value” means that an absolute value of the pixel voltage value is a minimum value, and “increase of pixel voltage value” means that an absolute value of pixel voltage value increases.

The control line 14 partitions a display area into a plurality of TMC pixels. And a control signal of a predetermined cycle voltage is applied on the control line 14.

The optical passive element 15 is an element which changes its resistance value according to brightness of an incident light, and one side end terminal is connected to the control line 14, and the other side end terminal is connected to the pixel electrode 12b.

Therefore, when the light is incident on the optical passive element 15, the resistance value of this optical passive element 15 becomes low, and thereby the control signal of the control line 14 is applied to the pixel electrode 12b.

That is, when a strong bright light is incident on the optical passive element 15, the resistance value of optical passive element 15 becomes low, and the voltage value of the pixel electrode 12b becomes almost the same voltage value as the control signal. On the other hand, when a weak light is incident on the optical passive element 15, the resistance value of the optical passive element 15 becomes high, and the voltage value of the pixel electrode 12b becomes into the voltage value lower than the control signal.

As a result, the electric field strength between the pixel electrode 12b and the common electrode 12a changes according to brightness of the incident light.

The liquid crystal molecules rotate due to the electric field. And a light which passes the liquid crystal 13 receives deflection caused by the rotation state of the liquid crystal molecules.

In addition, the liquid crystal 13 is located between the two polarizers 16a and 16b. Therefore, the light of same deflection direction as the polarizer 16b is incident on the liquid crystal 13, and this light receives the deflection depending on the rotation state of the liquid crystal molecules. And, finally the light of the same deflection direction as the polarizer 16a emitted.

Consequently, because the brightness of the emission light from polarizer 16a changes depending on the rotation state of the liquid crystal 13, thereby, the contrast ratio can be controlled.

Thus, because the optical passive element operates according to the brightness of the incidence light, the TMC device does not need to synchronize with the LCD device.

Accordingly, the structure of the TMC pixel 135 could differ from the display pixel 115, and the position of the TMC pixel 135 may shift from the display pixel 115.

Moreover, the TMC device does not require an exclusive signal generating circuit and a drive circuit, thereby, the manufacturing process becomes simple and manufacturing cost becomes cheap.

### (III) The Second Embodiment

The second embodiment will be described. An image display apparatus 20 includes an LCD device 30, a TMC device 40 and a backlight device 25.

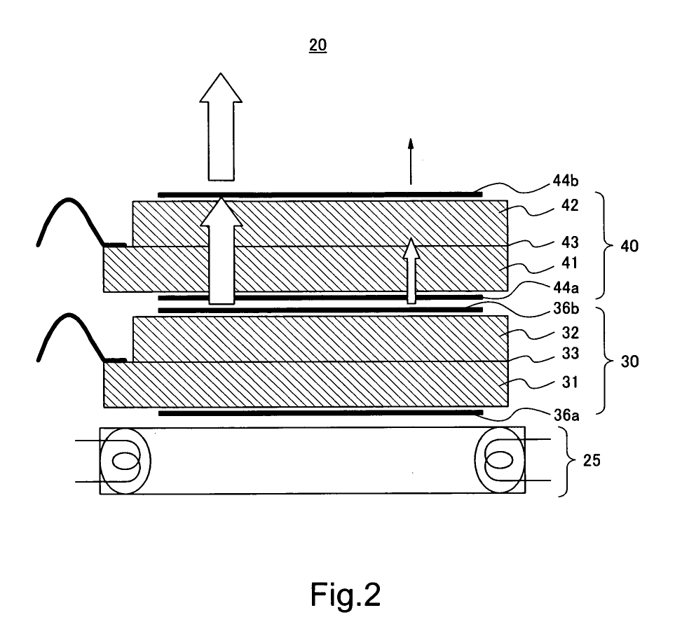

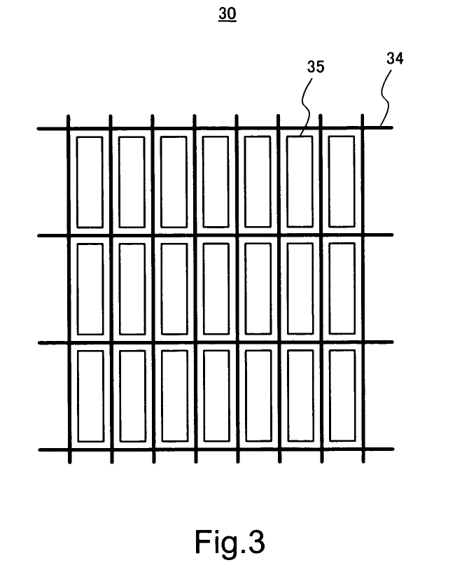

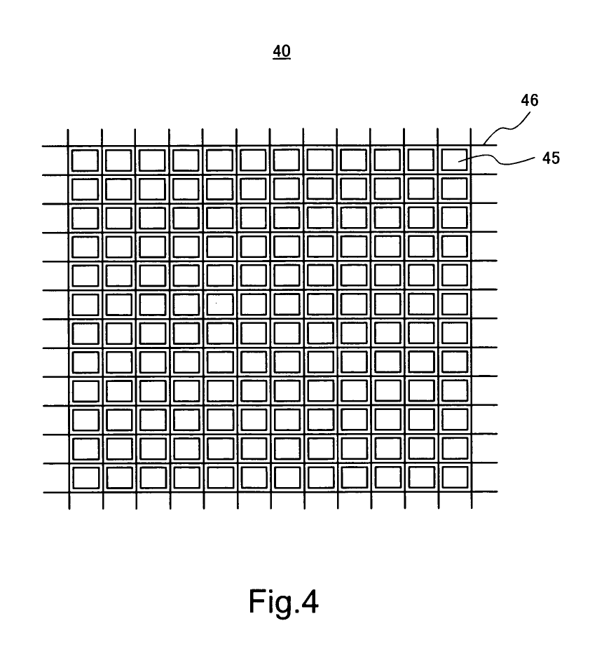

FIG. 2 indicates a cross section of the image display apparatus 20, and FIG. 3 indicates a plan view of the LCD device 30, and FIG. 4 indicates a plan view of a TMC device 40.

### (A) The LCD Device

The LCD device 30 shown in FIG. 2 includes a pair of transparent substrates 31 and 32, a liquid crystal 33, and polarizers 36a and 36b.

Transparent substrate 31 is provided with driving line 34, such as scanning lines (not shown) and data lines (not shown), a pixel electrode (not shown), and a polarizer 36a. The transparent substrate 32 is provided with common electrode (not shown) and a polarizer 36b.

The driving line 34 partitions the display area in a plurality of display pixels 35. Only the light of a specific deflection direction passes through the polarizers 36a and 36b respectively. Accordingly, an incident light to the liquid crystal 33 is the light selected by a polarizer 36a, and this selected light deflects by the liquid crystal 33, and only light which matches the deflection direction of the polarizer 36b is emitted.

### (B) The TMC Device

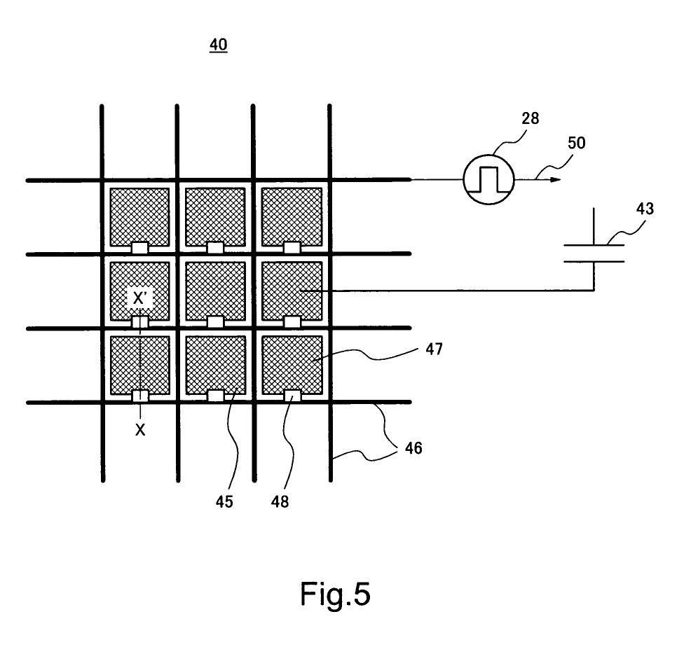

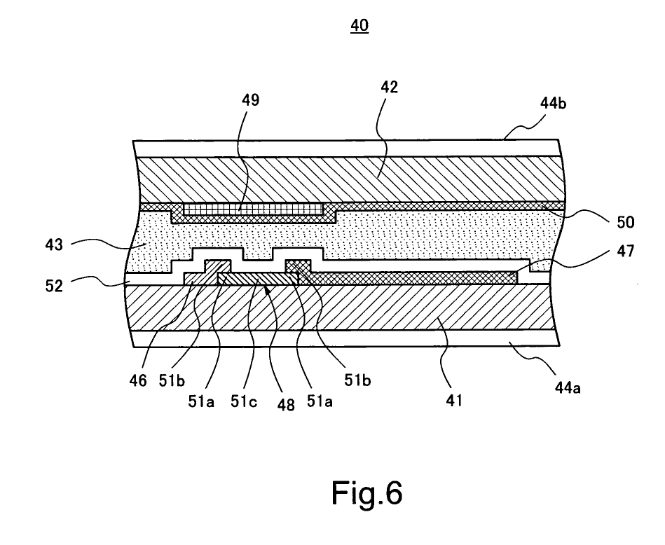

FIG. 5 indicates a detailed plan view of the TMC device 40, and FIG. 6 indicates a cross section along the X-X′ line of FIG. 5. As shown in FIG. 5 and FIG. 6, the TMC device 40 includes the INTS (incident side transparent substrate) 41, the EMTS (emission side transparent substrate) 42 and a liquid crystal 43.

The alignment film (not shown) is formed on the INTS 41 and the EMTS 42 as an alignment layer. A Rubbing treatment is performed to the alignment layer.

And the interval of the INTS 41 and the EMTS 42 is held by spacers (not shown), and liquid crystal 43 is filled into the gap their between.

The polarizer 44a is located at an incidence side position of the INTS 41, and the polarizer 44b is located at an emission side position of the EMTS 42. The polarizer 36b or the polarizer 44a can be omitted.

The EMTS 42 includes a light shielding layer 49 and a common electrode 50. The common electrode 50 is formed with transparent conductive material such as ITO (Indium Tin Oxide), and is formed on one side position of the EMTS 42. The INTS 41 includes a control line 46, pixel electrodes 47, optical passive elements 48 and passivation layer 52.

The control line 46 is formed from the conductive material such as aluminum, and partitions a display area in a plurality of the TMC pixels 45. It is not necessary to make the TMC pixel 45 into the same structures (for example, shape, area, the locating position, etc.) as the display pixel.

The pixel electrode 47 and the optical passive element 48 are formed in each TMC pixel 45. The optical passive element 48 comprises an active part 51c and joint parts 51a as the connecting terminal at both ends, and is formed with the semiconductor, such as an amorphous silicone and a polysilicon. One joint part 51a is connected with the control line 46, and another joint part 51a is connected with the pixel electrode 47. Hereinafter, each of connection regions of the control line 46 and the pixel electrode 47 which is connected with the joint part 51a of the optical passive element is described as the joint part 51b.

And when the light is incident the optical passive element 48, light excitation of free carries will be happened in the optical passive element 48. The amount of excited carrier is proportional to the brightness of the incident light. Therefore, the resistance value of the optical passive element 48 varies depending on the brightness of the incident light, and the conductive state between the control line 46 and the pixel electrode 47 changes.

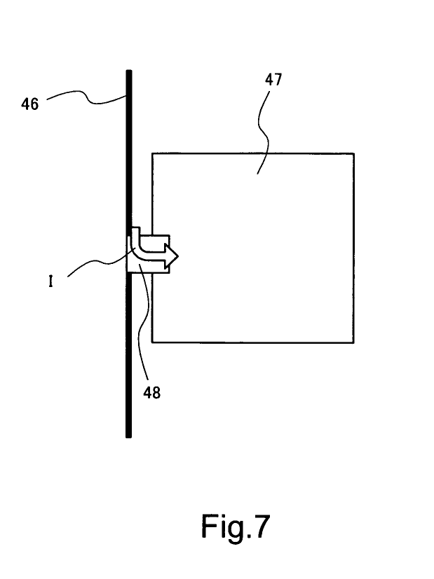

Corresponding to the change of the conductive state, a value of an electric current I (refer to FIG. 7) which flows into the pixel electrode 47 also changes. Because the light shielding layer 49 shades ambient light which enters the optical passive element 48 from the direction of the EMTS 42, the optical passive element 48 functions only by light from the LCD device 30.

As shown in FIG. 5, the control signal is supplied from an external power supply 28 to the control line 46. The control signal is a rectangular pulse of several kHz-several hundred kHz, and a peak voltage is 2-20 volts, and a polarity changes for each half cycle. On the other hand, DC voltage is supplied to the common electrode 50. In this embodiment, this DC voltage is a zero volt.

When the control line 46 is formed with a material without transparency of lights, such as aluminum, and the position of the joint part 51b is the incidence light side position compared with a position of the joint part 51a, the light is not incident on the joint part 51a, because it is shielded by the joint part 51b.

In this case, because the light is not incident on the joint part 51a, the resistance value of the joint part 51a does not become small; therefore the electric current does not flow into the pixel electrode 47 from the control line 46. Thereby as shown in FIG. 6, the joint part 51a is located more to an incidence light side position compared with the joint part 51b. Herewith, the light from the LCD device 30 comes to be incident on the joint part 51a and the active part 51c, and the electric current flows into the pixel electrode 47 from the control line 46.

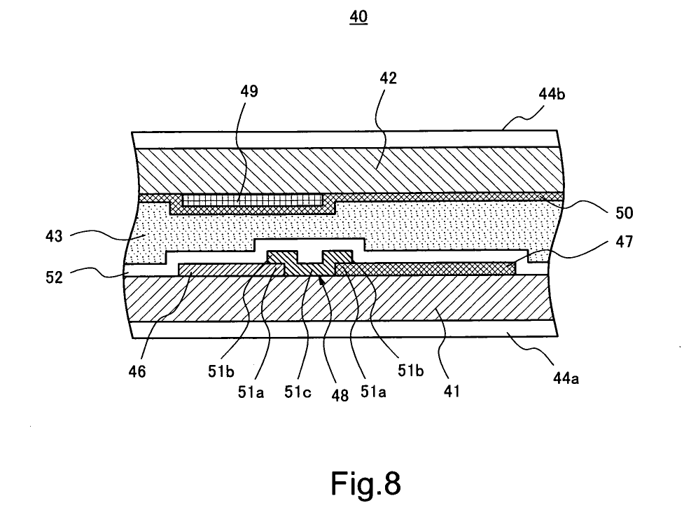

However, the present invention does not exclude the structure which the joint part 51b locates to the incidence light side compared with the joint part 51a as shown in FIG. 8.

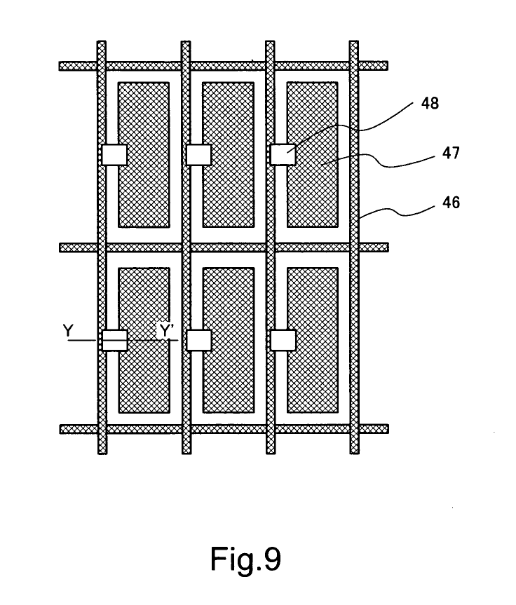

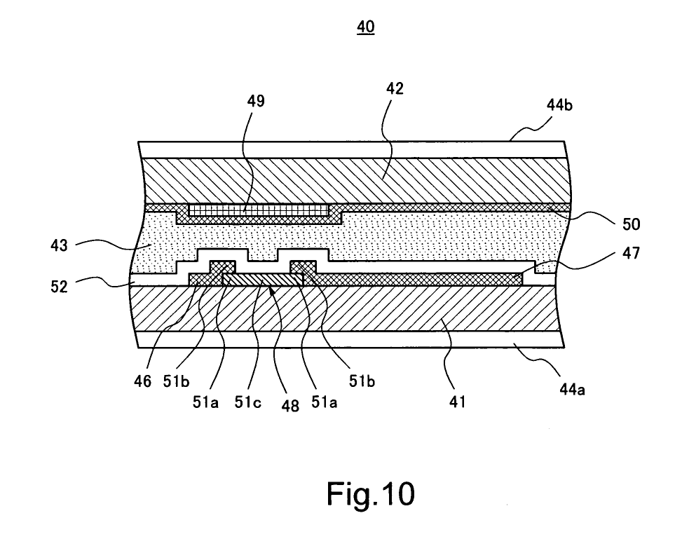

As shown in FIG. 9 and FIG. 10, the control line 46 is formed with the translucency material, and therefore the light can be incident on the joint part 51a. FIG. 9 is a plan view of the TMC device 40 provided with the control line 46 formed with the translucency material, such as ITO. FIG. 10 is a cross section along the Y-Y′ line of FIG. 9.

The above-mentioned structure has further advantage which the control line 46 and the pixel electrode 47 can form simultaneously, therefore a manufacturing process can be simplified, a manufacturing time can be shortened and a manufacturing cost becomes cheap.

Because the TMC device does not have to carry out the synchronous operation with the LCD device, the control signal generating circuit becomes simple. Accordingly, the cost of the TMC device becomes cheap.

Further, because the control line includes neither the scanning lines nor the data lines, the occupation area becomes small, and therefore the open area ratio becomes large.

### (C) The Image Display Apparatus

The image display apparatus 20 is formed by piling up the TMC device 40 on the LCD device 30.

In this case, because the TMC device 40 does not need to perform synchronous operation with the LCD device 30, the alignment of the TMC device 40 and the LCD device 30 does not require a high accuracy. As a result, the TMC device and the image display apparatus using this TMC device can be produced easily with low cost.

### (D) The Operation of the Image Display Apparatus

The image display apparatus 20 operates by starting the LCD device 30, the TMC device 40 and the backlight device 25. The light which has the brightness according to the image data from each display pixels of the LCD device 30 is incident on the optical passive element 48 of TMC device 40, and the resistance value of the optical passive element 48 changes.

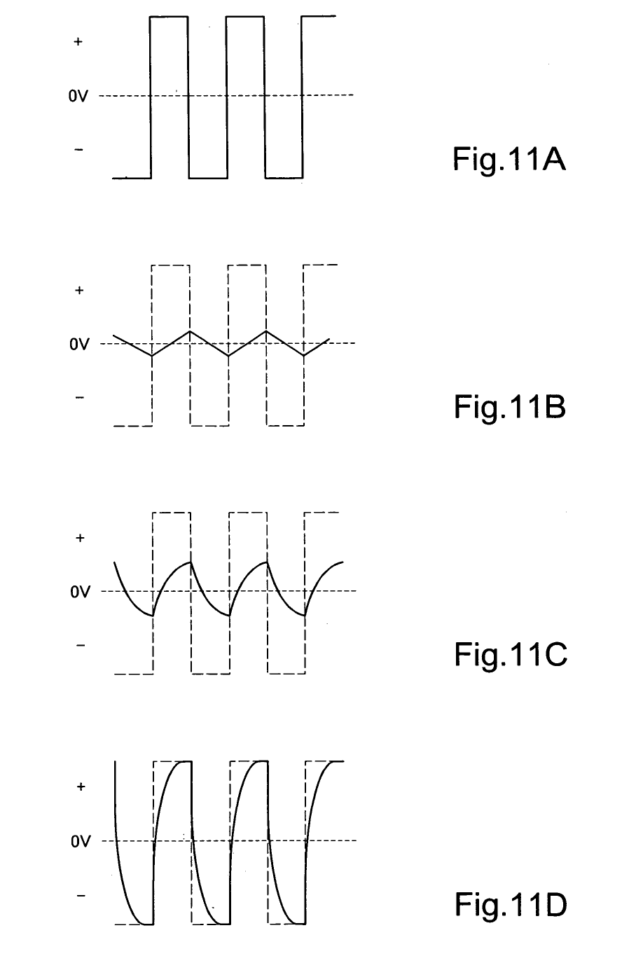

FIG. 11A indicates a voltage waveform of the control signal of the control line 46, and FIGS. 11B to 11D indicate voltage waveforms each applied on the pixel electrode 47 according to a resistance value of the optical passive element 48. FIG. 11B indicates in case of the incident light of the weak brightness and FIG. 11C indicates in case of the incident light of the medium degree brightness, and FIG. 11D indicates in case of the incident light of the strong brightness.

In these drawings, the waveform of the dotted line indicates the voltage waveform of the control signal. While the voltage waveform of the control signal is a rectangle, the voltage waveform on the pixel electrode 47 is a curve waveform.

The reason the voltage waveform on the pixel voltage turns into the curve waveform is because the time constant by the optical passive element 48 exists, and the time constant will become small when the resistance becomes small. When the pulse width of the control signal is longer sufficiently than the time constant, the voltage value on the pixel electrode 47 reaches a constant voltage value irrespective of the resistance value of the optical passive element 48.

Accordingly, by setting the pulse width of the control signal in a time interval which is not long sufficiently compared with the time constant, the voltage value on the pixel electrode 47 will be the voltage value corresponding to the resistance value.

Moreover, because the polarity of the control signal changes for each half cycle, an electric charge accumulated in the pixel electrode 47 discharges electricity for each half cycle. Accordingly, the voltage value of the pixel electrode 47 will be the voltage value corresponding to the brightness of the incident light without an influence of the electric charge accumulated by the previous cycle.

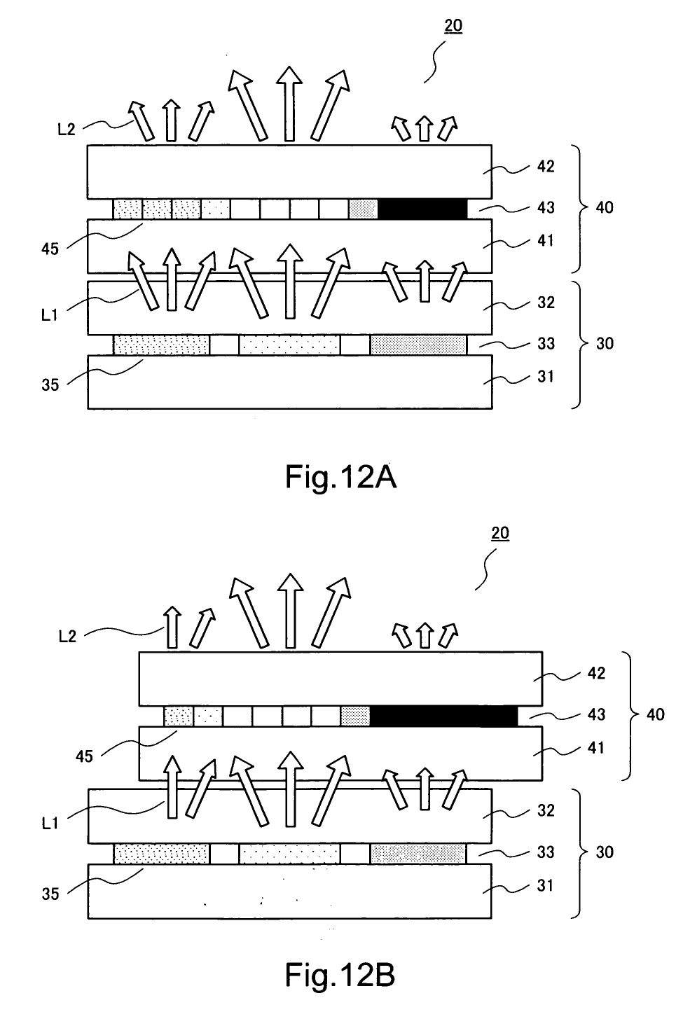

As shown in FIG. 12A and FIG. 12B, the light of brightness corresponding to image data is incident on the TMC device 40 from each display pixel 35. FIG. 12A indicates a cross section of the image display apparatus 20 which the TMC device 40 aligned with the LCD device 30, and FIG. 12B indicates a cross section of the image display apparatus 20 by which the TMC device 40 is not aligned with the LCD device 30.

The density of dots of the LCD device 30 shown in FIG. 12A and FIG. 12B indicates brightness of the light emitted from the display pixel 35, and when the dot density becomes large, the brightness of the emitted light from the display pixel 35 becomes small. The density of dots of the TMC device 40 shown in FIG. 12A and FIG. 12B indicates the transmittance factor of the TMC pixel 45, and when the dot density becomes large, the transmittance factor becomes small. An arrow L1 in FIG. 12A and FIG. 12B indicates the light emitted from the LCD device 30, and an arrow L2 in FIG. 12A and FIG. 12B indicates the light emitted from the TMC device 40. The length of these arrows L1 and L2 corresponds to the brightness of the light.

Because the light from the display pixel 35 enters the TMC pixel 45, the resistance value of the optical passive element 48 changes according to the brightness of the light. Therefore, the resistance value of the optical passive element 48 which strong brightness light entered becomes small and the resistance value of the optical passive element 48 which weak brightness light entered is large.

In this way, because the voltage value on the pixel electrode 47 will be the voltage value according to the brightness of the incident light, the electric field between the pixel electrode 47 and the common electrode 50 will be also the value according to the brightness of the incident light.

The liquid crystal molecules rotate by the electric field, and their rotational state varies depending on the strength of electric field. The light which passes the liquid crystal receives a deflection according to the rotational state of the liquid crystal molecules.

As shown in FIG. 6, because the polarizer 44b is provided on the TMC device 40, the transmitted light in the same deflection direction as the deflection direction of the polarizer 44b will be emitted.

As supposed, the TMC device 40 of this embodiment is the normally black type. That is, when the voltage value on the pixel electrode 47 is the smallest, the transmittance factor becomes the smallest, and when the voltage value on the pixel electrode 47 becomes large, the transmittance factor also becomes large.

Accordingly, when the strong brightness light enters the TMC pixel, the strong brightness light is emitted from the TMC pixel, and when the weak brightness light enters the TMC pixel, the brightness light weaker than the incident light is emitted from the TMC pixel. Therefore, the contrast ratio improves.

### (IV) The Other Embodiments

Several other embodiments will be described below. In the above-mentioned embodiment, the shape of the display pixel 35 and the shape of the TMC pixel 45 are similar figures.

However, the present invention does not require that the shape of the display pixel 35 and the shape of the TMC pixel 45 should be similar shapes. The optical passive element 48 operates by emission light from the LCD device 30. That is, the TMC pixel 45 responds to incident light automatically, and operates.

For this reason, the TMC pixel 45 does not need to be individually controlled from the outside. That is, the synchronous operation of the TMC pixel 45 and the display pixel 35 does not have to be carried out. As a result, restrictions about pixel shape etc. of TMC pixel 45 become unnecessary.

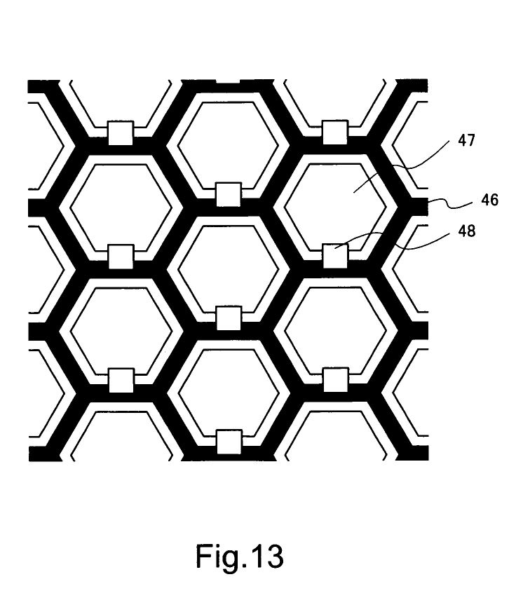

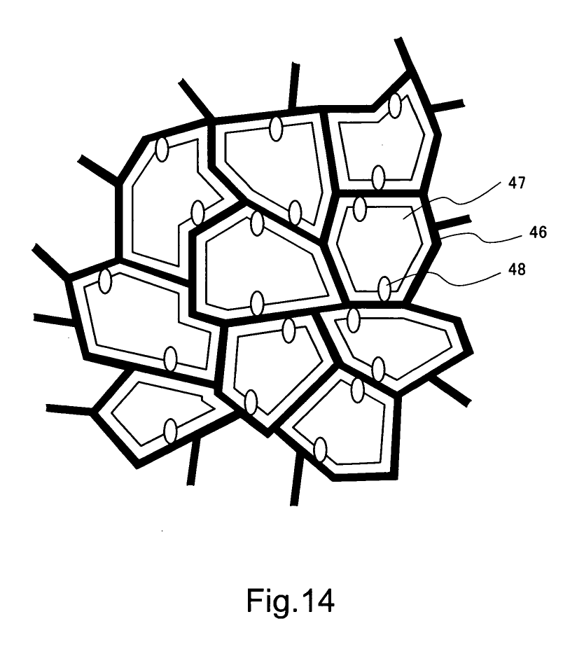

As the shape of the TMC pixel 45, a hexagonal shape as shown in FIG. 13 and an irregular shape as shown in FIG. 14 can be exemplified. Thus, because the similarity of the shape is not required, the moire by interference of light from each TMC pixel 45 etc. can be reduced.

In the above-mentioned embodiment, when the optical passive element 48 is connected with the control line 46 and the pixel electrode 47, it is not performed to make the resistance value of the joint part 51a smaller than the active part 51c. However, because the optical passive element 48 is the semiconductor, Schottky barrier generates in the connecting face with the metal or the like.

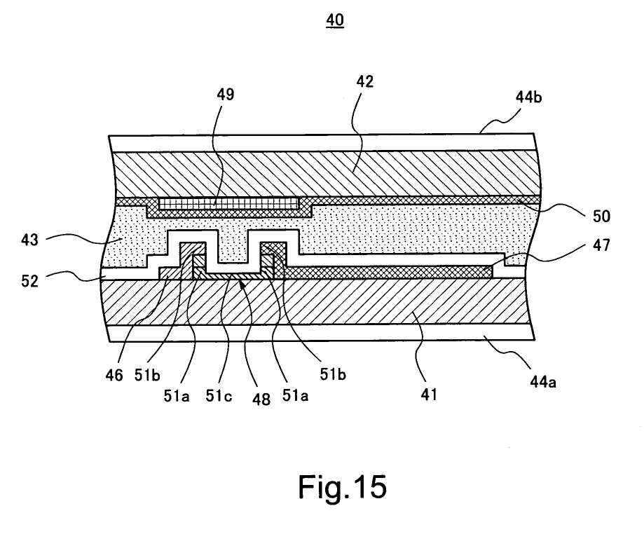

In this case, as shown in FIG. 15, the joint part 51a is made an n⁺silicon by increasing an impurity concentration of the joint part 51a.

In the above-mentioned embodiment, although one TMC pixel is equipped with one optical passive element, one TMC pixel may have a plurality of optical passive elements. And a channel width of the optical passive element may be changed depending on the pixel area.

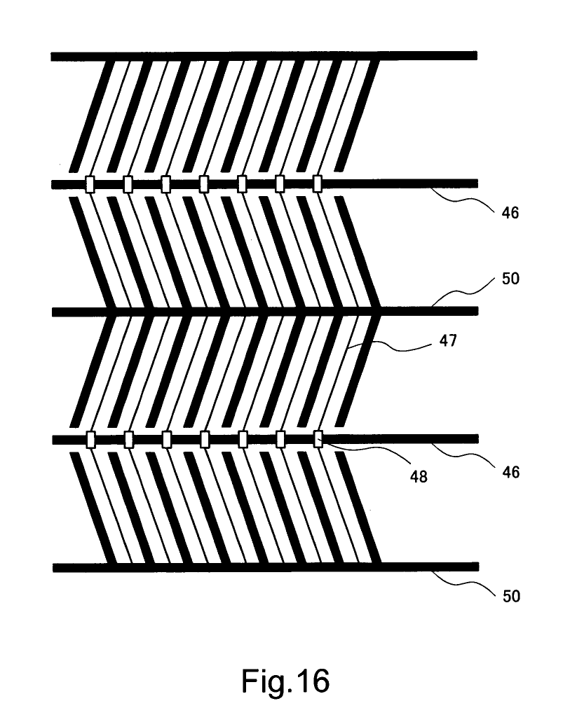

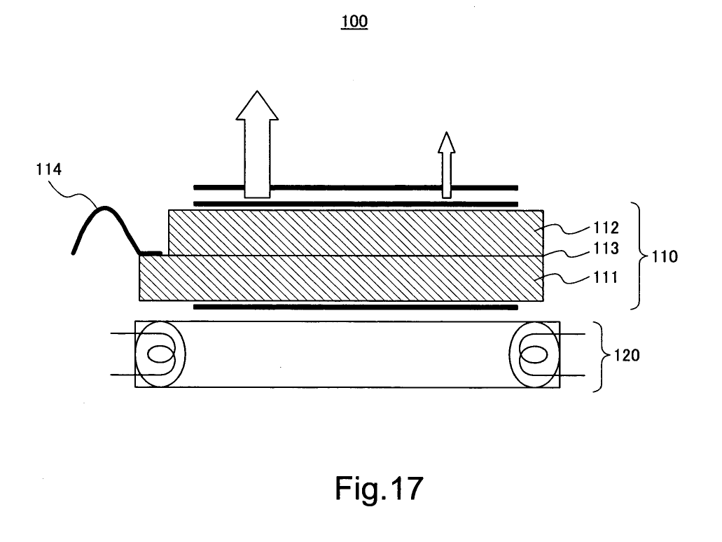

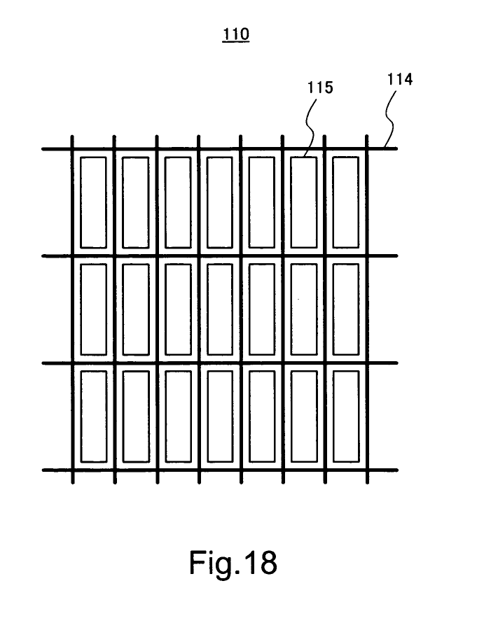

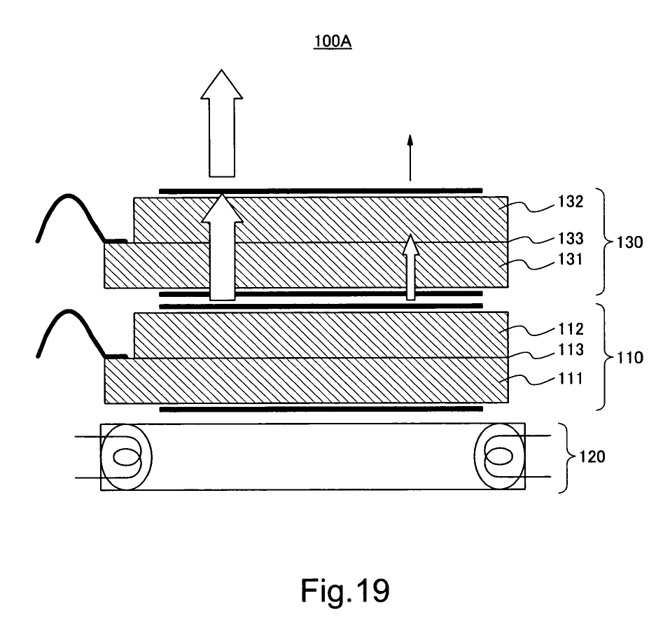

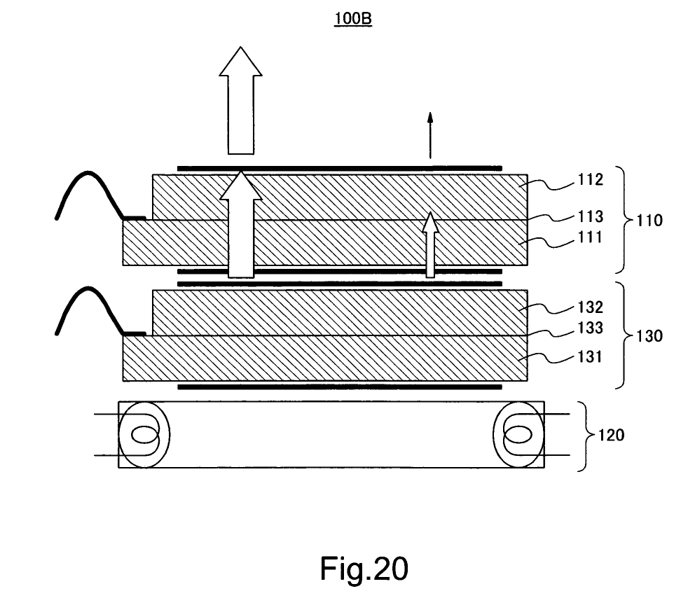

In the above-mentioned embodiment, the TMC device 40 is a vertical electric field system which an electric field generates between the pixel electrode 47 of the INTS 41 and the common electrode 50 of the EMTS 42. However, the TMC device 40 may be a horizontal electric field system such as the IPS system as shown in FIG. 16. The INTS 41 shown in FIG. 16 includes a control line 46, a pixel electrode 47 and a common electrode 50, and the liquid crystal molecule rotates in the horizontal direction by horizontal electric field which forms between the pixel electrode 47 and the common electrode 50. By such configuration, a view angle characteristic of the TMC device 40 improves remarkably.

The TMC device 40 which changes the transmittance factor according to the strength of the light from the LCD device of the present invention brings the following effect.

Because the operation of the TMC device performs asynchronous operation to the LCD device, the structure of the TMC device becomes simpler than the LCD device, and the exclusive signal generating circuit and the driving circuit for generating synchronization signal becomes unnecessary.

Because the shape of the TMC pixel does not need to be made the same shape as the shape of the display pixel, it improves the display characterizes.

Further, the alignment of the high accuracy of the TMC device and the LCD device is not requested. Accordingly, assembly of the TMC device and the LCD device becomes easy also can reduce the production cost.

While the invention has been particularly shown and described with reference to exemplary embodiments thereof, the invention is not limited to these embodiments.

It will be understood by those of ordinary skill in the art that various changes in form and details may be made therein without departing from the spirit and scope of the present invention as defined by the claims.

What is claimed is:

1. A transmittance control device which controls a transmittance factor, comprising:
a liquid crystal which is sandwiched with a pixel electrode and a common electrode;
a control line which a predetermined control signal inputs; and
an optical passive element which controls an electric potential difference on the pixel electrode and the common electrode by connecting with the control line and the pixel electrode, and changing a conduction state of the control line and the pixel electrode according to brightness of an incidence light.

2. The transmittance control device according to claim 1, further comprising:
a polarizer which only passes light with a predetermined deflection direction.

3. The transmittance control device according to claim 2, wherein
the optical passive element changes a resistance value according to the brightness of the incident light.

4. The transmittance control device according to claim 3, wherein
the control line, the pixel electrode and the optical passive element are formed on an one transparent substrate; and
the common electrode is formed on an other transparent substrate.

5. The transmittance control device according to claim 3, wherein
the control line, the pixel electrode, the optical passive element and the common electrode are formed on an one transparent substrate.

6. The transmittance control device according to claim 2, wherein
a joint part of the optical passive element is provided in the position of the incident light side more than the control line.

7. The transmittance control device according to claim 2, further comprising:
a light shielding layer which shades a stray light to the optical passive element.

8. The transmittance control device according to claim 7, wherein
the optical passive element is an amorphous silicon semiconductor.

9. The transmittance control device according to claim 8, wherein
the optical passive element is a polysilicon semiconductor.

10. The transmittance control device according to claim 7, wherein
at least one of the control line, the pixel electrodes and the common electrodes is a conductive material of the translucency.

11. The transmittance control device according to claim 2, wherein
the control signal is a pulse signal which polarity reverses for each half cycle with a predetermined pulse width.

12. An image display apparatus which indicates an image data, comprising:
a liquid crystal display device which emits a light according to the image data; and
a transmittance control device which changes a transmittance factor according to brightness of an emitted light from the liquid crystal display device.

13. The image display apparatus according to claim 12, further comprising:
a backlight device of an incident light source of the liquid crystal display device.

14. The image display apparatus according to claim 13, wherein
the transmittance control device including:
an optical passive element which changes a resistance according to the brightness of the incident light;
a control line from which a predetermined control signal is inputted;
a pixel electrode which the control signal inputs from the control line according to the resistance value of the optical passive element; and
a common electrode which sandwiches a liquid crystal by the pixel electrode.

15. The image display apparatus according to claim 13, further comprising:
a polarizer which passes a light with a predetermined deflection direction.

16. The image display apparatus according to claim 14, wherein
the liquid crystal display device is partitioned by a plurality of display pixels and the transmittance control device is partitioned by a plurality of transmittance control pixels, and at least one of a shapes and an areas of the display pixel and the transmittance control pixel is different.
